(19) United States
(12) Patent Application Publication
(10) Pub. No.: US 2017/0220135 A1
(43) Pub. Date: Aug. 3, 2017

(54) DISPLAY DEVICE AND DISPLAY CONTROL METHOD

(71) Applicant: FUJITSU LIMITED, Kawasaki-shi (JP)

(72) Inventors: Shuichi ABE, Sapporo (JP); Akira SHINOZAWA, Sapporo (JP); Toru KOHEI, Kawasaki (JP)

(73) Assignee: FUJITSU LIMITED, Kawasaki-shi (JP)

(21) Appl. No.: 15/379,471

(22) Filed: Dec. 14, 2016

(30) Foreign Application Priority Data
Jan. 28, 2016 (JP) 2016-014823

(51) Int. Cl. G06F 3/0346; G06F 3/041

(52) U.S. Cl. CPC G06F 3/0346; G06F 3/0412; G06F 3/0416; G06F 2203/04105

(57) ABSTRACT

There is provided a display device includes: a memory; and a processor coupled with the memory and the processor configured to: detect a tilt of the display device; detect a touch position touched on a touch panel of the display device; and point a position different from the touch position detected, based on the tilt detected, the touch position detected, and a first distance from a reference position on the touch panel to the touch position detected.

### CROSS-REFERENCE TO RELATED APPLICATION

This application is based upon and claims the benefit of priority of the prior Japanese Patent Application No. 2016-014823, filed on Jan. 28, 2016, the entire contents of which are incorporated herein by reference.

### FIELD

The embodiment discussed herein is related to a display device and a display control method.

### BACKGROUND

Conventionally, there are touch panels which each display a screen and, in response to touching of a display surface by the finger of a user, a pen or the like, accept pointing of a position touched by the user on the display surface. The touch panel detects the finger of the user, the pen, or the like touching the display surface by using, for example, a resistive method, a capacitive method, an ultrasonic method, an optical method, an electromagnetic induction method, or the like.

Related prior arts include, for example, a technique in which a reference position is set on an outer periphery side of an input portion outside a position where a reference setting operation is performed in the input portion, and a display position of a selection index for selecting a position in a display portion is set according to the reference position and a position where a position pointing operation is performed. Moreover, for example, there is a technique in which, based on a predetermined reference point and a position pointed by using a pen or a touch panel, the coordinates of a virtual pointed position pointed by using the pen or the touch panel are calculated and the calculated coordinates of the virtual pointed position are outputted.

Such conventional techniques are disclosed in, for example, Japanese Laid-open Patent Publication Nos. 2014-153948 and 2004-78323.

### SUMMARY

According to an aspect of the invention, a display device includes: a memory; and a processor coupled with the memory and the processor configured to: detect a tilt of the display device; detect a touch position touched on a touch panel of the display device; and point a position different from the touch position detected, based on the tilt detected, the touch position detected, and a first distance from a reference position on the touch panel to the touch position detected.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 includes explanatory diagrams illustrating an example of a display control method in an embodiment;

FIG. 2 is a block diagram illustrating a hardware configuration example of a display device;

FIG. 3 is an explanatory diagram illustrating an example of storage contents in a position management table;

FIG. 4 is an explanatory diagram illustrating an example of storage contents in a coefficient management table;

FIG. 5 is an explanatory diagram illustrating an example of storage contents in a touch management table;

FIG. 6 is an explanatory diagram illustrating an example of storage contents in a mode management table;

FIG. 7 is a block diagram illustrating a functional configuration example of the display device;

FIG. 8 includes explanatory diagrams illustrating an example of the display device pointing a position;

FIG. 9 includes explanatory diagrams illustrating another example of the display device pointing a position;

FIG. 10 includes explanatory diagrams illustrating an example of changing the pointed position in the display device;

FIG. 11 includes explanatory diagrams illustrating another example of changing the pointed position in the display device;

FIG. 12 is an explanatory diagram illustrating an example of a user operation input into the display device;

FIG. 13 includes explanatory diagrams (part 1) illustrating an example of a user pointing a desired position;

FIG. 14 includes explanatory diagrams (part 2) illustrating the example of the user pointing the desired position;

FIG. 15 includes explanatory diagrams (part 3) illustrating the example of the user pointing the desired position;

FIG. 16 is a flowchart (part 1) illustrating an example of a pointing process procedure; and

FIG. 17 is a flowchart (part 2) illustrating the example of the pointing process procedure.

### DESCRIPTION OF EMBODIMENT

In the conventional techniques described above, it is sometimes difficult for the user to point a desired position on a touch panel. For example, while the user is holding the touch panel, the user is usually unable to point a position on the touch panel which is out of reach of the fingers of the hand holding the touch panel. Moreover, for example, there is a case where, in response to touching of the panel touched by the user, the pointed position is set to a position away from a reference position in a direction passing the actually touched position, by a distance obtained by multiplying a distance from the reference position to the touch position by a predetermined multiplying factor. In this case, however, pointing of the desired position is sometimes difficult since the multiplying factor is fixed.

Exemplary embodiments for a technique which are capable of improving operability of a touch panel are described below in detail with reference to the drawings.

### [Example of Display Control Method in Embodiment]

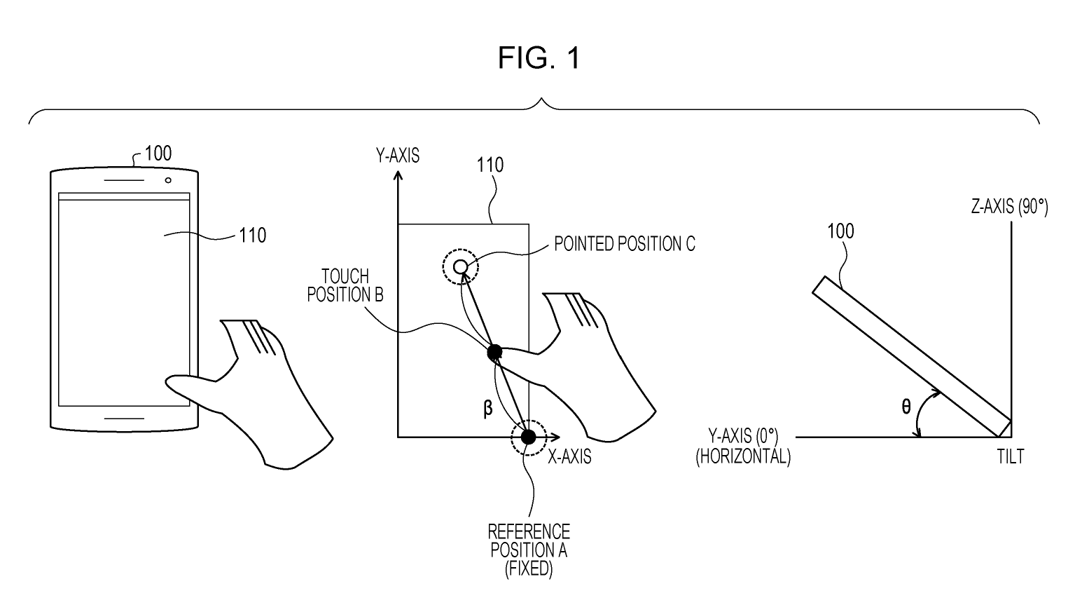

FIG. 1 includes explanatory diagrams illustrating an example of a display control method in the embodiment. A display device 100 includes a touch panel 110 and is a computer which assists an operation input performed by the user on the touch panel 110. The display device 100 is specifically a smartphone, a tablet terminal, or the like. The touch panel 110 is an input-output device which displays a screen and accepts pointing of a touch position on the touch panel 110 in response to touching of the touch panel 110 by the finger of the user, a pen, or the like.

In recent years, there has been a demand to enlarge a display surface of a touch panel 110 included in the terminal device to improve visibility and increase the amount of displayable information. However, as the display screen becomes larger, pointing of a desired position on the touch panel 110 tends to become more difficult for the user of the terminal device. For example, when the terminal device is a tablet terminal and the user is holding the tablet terminal with both hands, any of the fingers of both hands does not reach a center portion of the touch panel 110 and the user is thus unable to point the center portion of the touch panel 110. Moreover, for example, when the user lets go of one of the hands from the terminal device to point the center portion of the touch panel 110, the user may drop and break the terminal device.

Moreover, the user sometimes desires to operate the terminal device with one hand. For example, in a train, there is a case where the user grabs a strap with one hand and holds the terminal device with the other hand and, in this state, operates the terminal device with the hand holding the terminal device. However, when the user operates the terminal device with one hand, pointing of a desired position on the touch panel 110 tends to be difficult. For example, an area of the touch panel 110 within reach of the fingers of the hand holding the terminal device is limited, and the user is unable to point a position on the touch panel 110 out of reach of the fingers of the hand holding the terminal device.

Furthermore, in the conventional terminal device, it is conceivable to display a cursor at a position away from a reference position on the touch panel 110 in a direction passing a position touched by the user on the touch panel 110, by a distance obtained by multiplying a distance from the reference position to the touch position by a predetermined multiplying factor and to accept pointing of the position of the cursor. However, in this case, the multiplying factor by which the distance from the reference position to the touch position is multiplied is fixed, and it is sometimes difficult for the user to point a desired position on the touch panel 110.

Specifically, when the multiplying factor is set to such a value that the entire region of the touch panel 110 is selectable, the multiplying factor tends to be large and relatively small change of the position touched by the finger of the user sometimes results in relatively great change of the display position of the cursor. Accordingly, when the user tries to display the cursor roughly around a desired position other than an outer periphery of the touch panel 110, the user has to delicately adjust the position touched by the finger and has difficulty in displaying the cursor around the desired position. Moreover, when the user tries to move the cursor exactly to the desired position after the cursor is displayed, the pointing of the desired position is difficult because the display position of the cursor changes relatively greatly even if the position touched by the finger is changed relatively small.

Moreover, specifically, in order to point desired positions in the entire region of the touch panel 110, the user sometimes has to change the distance from the reference position to the touch position by changing the finger between a greatly bent state and a fully stretched-out state. Accordingly, the user sometimes has to delicately adjust the touch position with the finger greatly bent or to delicately adjust the touch position with the finger fully stretched out, and the pointing of the desired position is difficult.

In addition, specifically, the user tends to touch the touch panel 110 with the tip of the finger when the finger is greatly bent and tends to touch the touch panel 110 with the ball of the finger when the finger is fully stretched out. Accordingly, the user sometimes has to perform operations with different feelings between when the finger is greatly bent and when the finger is fully stretched out. In the case of the capacitive touch panel 110, for example, when the tip of the finger of the user touches the touch panel 110, the touch panel 110 accepts pointing of a position where the tip of the finger touches the touch panel 110. Meanwhile, when the ball of the finger of the user touches the touch panel 110, the touch panel 110 accepts pointing of a position where a center portion of the ball of the finger touches the touch panel 110. Hence, the user operates the display device 100 with the different feelings.

Furthermore, specifically, since the length of the finger varies from one user to another, there may be a user among various users who has difficulty in pointing of a desired position on the touch panel 110. To be more specific, when the predetermined multiplying factor is set to suit the user with the relatively long fingers, the user with the relatively short fingers is sometimes unable to point an end of the touch panel 110.

Moreover, in the conventional terminal device, it is conceivable to redisplay display contents with a reduced size on the side of the touch panel 110 close to the holding hand of the user, and then accept the pointing of the position touched by the user on the touch panel 110. However, in this case, since the size of the display contents is reduced, the visibility may decrease. Moreover, a range desired to be pointed by the user also becomes small and the pointing of the position desired by the user may become difficult.

Accordingly, in the embodiment, description is given of the display control method which may improve the operability of the touch panel 110 in the pointing of a position on the touch panel 110, based on the tilt of the display device 100 in addition to the position on the touch panel 110 touched by the user.

In the example of FIG. 1, the display device 100 detects the tilt θ of itself. The display device 100 detects the tilt θ of itself with respect to the horizontal plane by using, for example, an acceleration sensor, an angular velocity sensor, or the like. Next, the display device 100 detects a touch position B on the touch panel 110. For example, the display device 100 detects the position B touched by the finger of the user or the pen on the touch panel 110, by using a resistive method, a capacitive method, an ultrasonic method, an optical method, an electromagnetic induction method, or the like. In the following description, the position touched by the finger of the user, the pen, or the like on the touch panel 110 is referred to as “touch position” in some cases.

Then, the display device 100 points a position C on the touch panel 110 which is different from the detected touch position B, based on the detected tilt θ, the touch position B, and a distance β from a reference position A to the touch position B on the touch panel 110. In the following description, the distance β from the reference position A to the touch position B is referred to as “reference distance β” in some cases.

The reference position A is a position being a reference in the pointing of the position C. The reference position A is, for example, a position capable of being varied depending on an operation input by the user. Specifically, when the user continuously touches the touch panel 110, the reference position A is the first touch position B among multiple continuously-touched positions. The distance β is specifically a distance from the reference position A to the latest touch position B among the multiple continuously-touched positions.

Alternatively, the reference position A may be, for example, a fixed position set in advance. The reference position A is specifically a position on the side close to the holding hand of the user among positions on an outer periphery of the touch panel 110. The reference position A may specifically be a position on the opposite side to the holding hand of the user among the positions on the outer periphery of the touch panel 110.

Specifically, when the first touch position B of the user is used as the reference position A, the display device 100 points the position C on the touch panel 110 away from the reference position A in a direction passing the touch position B, by a distance obtained by multiplying the reference distance β by a coefficient of 1 or more corresponding to the tilt θ. Meanwhile, specifically, when the position on the side close to the holding hand of the user is used as the reference position A, the display device 100 points the position C on the touch panel 110 away from the reference position A in the direction passing the touch position B, by a distance obtained by multiplying the reference distance β by a coefficient of 1 or more corresponding to the tilt θ.

Furthermore, specifically, when the position on the opposite side to the holding hand of the user is used as the reference position A, the display device 100 points a position on the touch panel 110 which is closer to the reference position A than the touch position B is and which is away from the reference position A by a distance obtained by multiplying the reference distance β by a coefficient of 1 or less corresponding to the tilt θ. In the following description, the pointed position is referred to as “pointed position C” in some cases.

In addition, the display device 100 displays a cursor at the pointed position C. In the example of FIG. 1, the cursor is a circular symbol in a dotted line portion. The cursor may be an arrow-shaped mark. The cursor may be an arrow-shaped mark extending from the reference position A to the pointed position C. Then, the display device 100 accepts an operation input for the pointed position C at which the cursor is displayed, in response to a predetermined operation performed on the touch panel 110 after the display of the cursor. For example, the display device 100 accepts an operation input of tapping at the pointed position C at which the cursor is displayed, in response to tapping of the touch panel 110 performed within a predetermined time from a time point where the user temporarily stops touching the touch panel 110.

Moreover, the display device 100 may accept the operation input for the pointed position C without displaying the cursor, when the user touches the touch panel 110 and points the position C different from the touch position B. For example, the display device 100 may accept the operation input of tapping at the pointed position C when the user touches the touch panel 110 and points the position C different from the touch position B.

In the aforementioned method, the display device 100 may use the tilt of itself in addition to the reference distance corresponding to the touch position, as a parameter used in the pointing of the position, and increase the types of parameters adjustable by the user. The display device 100 is thus capable of improving the operability of the touch panel 110 by facilitating the pointing of the desired position by the user.

Specifically, when the user is holding the display device 100 with both hands, the user is able to point a position in the vicinity of the center of the touch panel 110 even if the user is unable to reach the vicinity of the center of the touch panel 110 with the fingers of both hands. Accordingly, the user does not have to let go of one hand from the terminal device to point the vicinity of the center of the touch panel 110. This may reduce the possibility of dropping the terminal device and thus reduce the possibility of breaking the display device 100.

Moreover, also when the user is holding the display device 100 with one hand and operates the display device 100 with the hand holding the display device 100, the user is able to point a position on the touch panel 110 which the user is unable to reach with the fingers of the hand holding the display device 100. The display device 100 is thus capable of improving the operability of the touch panel 110 by facilitating the pointing of the desired position also when the user is using one hand.

Moreover, when the user tries to point a vicinity of a desired position other than the outer periphery of the touch panel 110, the user only adjusts the tilt of the display device 100 and does not have to delicately adjust the touch position of the finger. Accordingly, it is easier for the user to roughly move the cursor to, for example, the vicinity of the desired position other than the outer periphery of the touch panel 110. In addition, when the user tries to delicately change the pointed position, the user may adjust the tilt of the display device 100 to suppress the case where relatively small change of the touch position of the finger causes relatively great change of the pointed position.

Furthermore, when the user tries to point desired positions in the entire region of the touch panel 110, the user only has to adjust the tilt of the display device 100 and does not have to change the finger between the greatly bent state and the fully stretched-out state. Accordingly, the user does not have to adjust the touch position with the finger greatly bent or with the finger fully stretched out, and may adjust the touch position with low stress on the finger. In addition, the user does not have to operate the display device 100 with the finger greatly bent or with the finger fully stretched out, and may operate the display device 100 with the same feeling for pointing of any positions in the entire region of the touch panel 110.

Moreover, the user may adjust the tilt of the display device 100 depending on the lengths of the fingers and more easily point the desired position on the touch panel 110. Accordingly, the display device 100 is capable of improving the operatively of the display device 100 when being used by the users with various finger lengths. In addition, the display device 100 does not have to reduce the sizes of the display contents of the touch panel 110 and is thus capable of avoiding decrease in visibility and facilitating the pointing of the desired position by the user.

Although the situation where the display device 100 points a position other than the touch position is described above, the embodiment is not limited to this situation. For example, there may be a situation where the display device 100 points the touch position, in addition to the situation where the display device 100 points a position other than the touch position. Specifically, the display device 100 may be switchable between a mode of pointing a position other than the touch position and a mode of pointing the touch position. In the following description, the mode in which the display device 100 points the touch position is sometimes referred to as “normal mode”. Moreover, in the following description, the mode in which the display device 100 points a position other than the touch position is sometimes referred to as “extension mode”.

### [Hardware Configuration Example of Display Device 100]

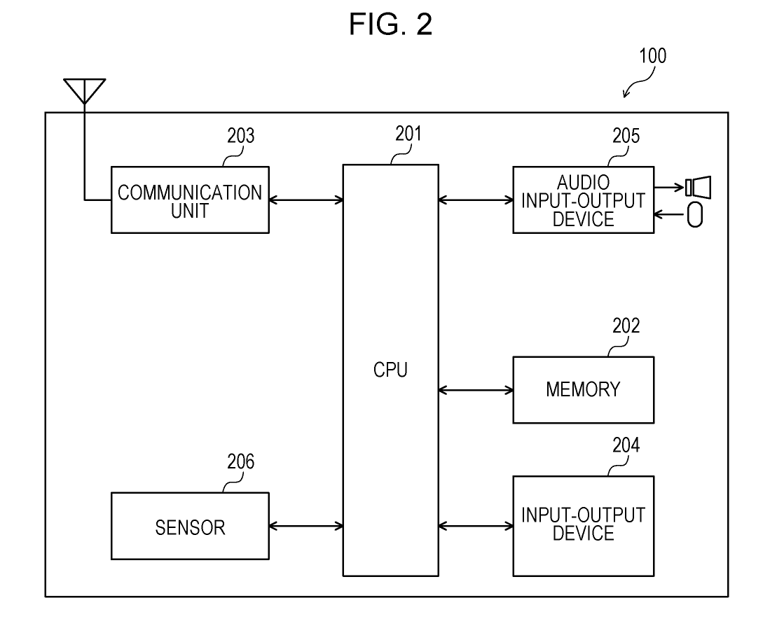

Next, a hardware configuration example of the display device 100 illustrated in FIG. 1 is described by using FIG. 2.

FIG. 2 is a block diagram illustrating the hardware configuration example of the display device 100. In FIG. 2, the display device 100 includes a central processing unit (CPU) 201, a memory 202, a communication unit 203, an input-output device 204, an audio input-output device 205, and a sensor 206. The constitutional units are connected to one another by, for example, a bus (not illustrated).

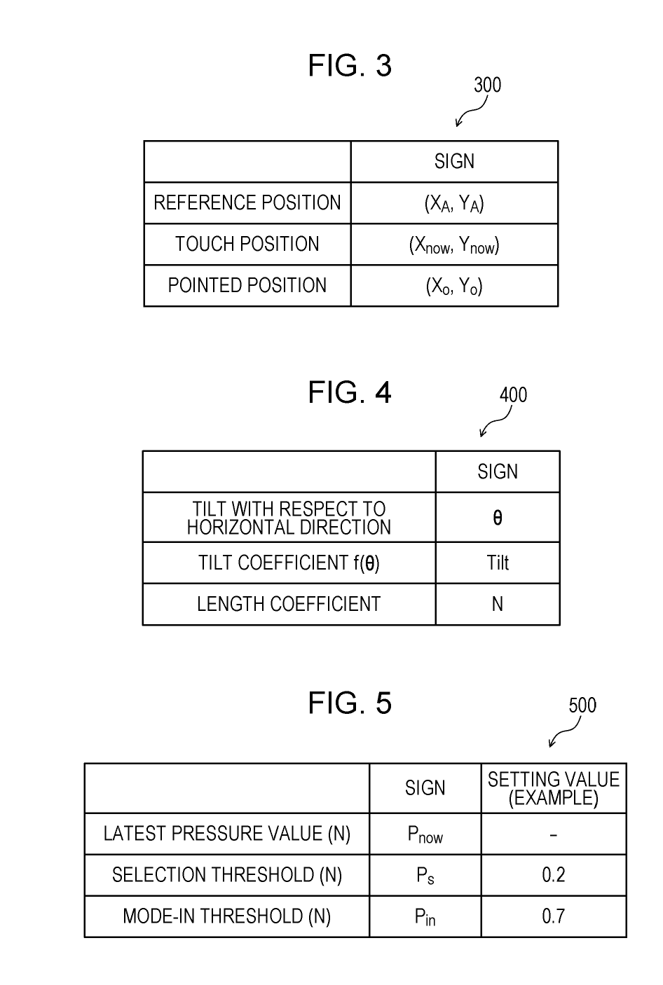

In this example, the CPU 201 is responsible for controlling the entire display device 100. The memory 202 includes, for example, a read only memory (ROM), a random access memory (RAM), a flash ROM, and the like. Specifically, for example, the flash ROM and the ROM store various programs and the RAM is used as a work area of the CPU 201. The programs stored in the memory 202 are loaded by the CPU 201 and cause the CPU 201 to execute coded processes. The memory 202 stores the various tables described later in FIGS. 3 to 6.

The communication unit 203 includes an antenna for 3rd generation (3G) communication, long term evolution (LTE) communication, or 4th generation (4G) communication, and performs 3G, LTE, or 4G communication to exchange data with a base station. The communication unit 203 inputs data received in the 3G, LTE, or 4G communication into the CPU 201 and outputs data to be transmitted in the 3G, LTE, or 4G communication from the CPU 201. The communication unit 203 is controlled by, for example, the CPU 201.

The input-output device 204 includes the touch panel 110 and performs input and output of data. The touch panel 110 includes a display which displays data such as documents, images, function information, and the like including the cursor, icons, and tool boxes. The display is for example a cathode ray tube (CRT) display, a liquid crystal display, an organic electroluminescence (EL) display, or the like. The touch panel 110 includes a detection device which is provided on the display or in a display outer peripheral portion and which detects the touch position of the user on the touch panel 110. The detection device detects the touch position by using, for example, the resistive method, the capacitive method, the ultrasonic method, the optical method, the electromagnetic induction method, or the like. The input-output device 204 may include, for example, a key pad for input of characters, numbers, various instructions, and the like, in addition to the touch panel 110. The input-output device 204 may include, for example, a keyboard, a mouse, and the like, in addition to the touch panel 110.

The audio input-output device 205 performs audio input and output in calls and outputs alarms, ringtones, and the like. The audio input-output device 205 includes, for example, a CODEC. For example, the CODEC converts an analog signal to a digital signal by use of pulse code modulation (PCM). The sensor 206 is an acceleration sensor or an angular velocity sensor. The sensor 206 detects the tilt of the display device 100 with respect to the horizontal plane and outputs data indicating the detected tilt to the CPU 201. The display device 100 may include, for example, an interface, a disc drive, a disk, a solid state drive (SSD), a semiconductor memory, a display, and the like in addition to the constitutional units described above.

### [Storage Contents of Various Tables]

Next, an example of storage contents of various tables stored in the display device 100 is described by using FIGS. 3 to 6. The various tables are implemented by, for example, the memory 202 of the display device 100 illustrated in FIG. 2.

### [Storage Contents of Position Management Table 300]

FIG. 3 is an explanatory diagram illustrating an example of storage contents in a position management table 300. As illustrated in FIG. 3, the position management table 300 includes fields for a reference position (X_{A}, Y_{A}), a touch position (X_{now}, Y_{now}), and a pointed position (X₀, Y₀). Position management information is stored in the position management table 300 by setting information in each field every time the user touches the touch panel 110.

The reference position (X_{A}, Y_{A}) is a position on the touch panel 110 which is used as a reference when the display device 100 points a position. X_{A} is a value of an X coordinate out of coordinates of the reference position on the touch panel 110. Y_{A} is a value of a Y coordinate out of the coordinates of the reference position on the touch panel 110. The reference position (X_{A}, Y_{A}) is a variable position set according to the operation input by the user. The reference position may be, for example, a fixed position set in advance.

The touch position (X_{now}, Y_{now}) is a position on the touch panel 110 which is touched by the user and which is detected by the display device 100. X_{now} is a value of an X coordinate out of coordinates of the position on the touch panel 110 which is touched by the user. Y_{now} is a value of a Y coordinate out of the coordinates of the position on the touch panel 110 which is touched by the user. The pointed position (X₀, Y₀) is a position pointed by the display device 100. X₀ is a value of an X coordinate out of coordinates of the pointed position on the touch panel 110. Y₀ is a value of a Y coordinate out of the coordinates of the pointed position on the touch panel 110.

### [Storage Contents of Coefficient Management Table 400]

FIG. 4 is an explanatory diagram illustrating an example of storage contents in a coefficient management table 400. As illustrated in FIG. 4, the coefficient management table 400 includes fields for the tilt θ, a tilt coefficient Tilt, and a length coefficient N. Coefficient management information is stored in the coefficient management table 400 by setting information in each field every time the tilt of the display device 100 is detected.

The tilt θ is the tilt of the display device 100 with respect to the horizontal plane. The tilt coefficient Tilt is a coefficient obtained based on the tilt θ. The tilt coefficient Tilt is a coefficient used when the display device 100 points the position (X₀, Y₀). The length coefficient N is a coefficient used when the display device 100 points the position (X₀, Y₀).

### [Storage Contents of Touch Management Table 500]

FIG. 5 is an explanatory diagram illustrating an example of storage contents in a touch management table 500. As illustrated in FIG. 5, the touch management table 500 includes fields for a latest pressure value P_{now}, a selection threshold Pₛ, and a mode-in threshold Pᵢₙ. Touch management information is stored in the touch management table 500 by setting information in each field every time the user touches the display device 100.

The latest pressure value P_{now} is a pressure which is detected by the display device 100 when the user touches the touch panel 110 and at which the touch panel 110 is pressed down. The unit of the latest pressure value P_{now} is Newton (N). The selection threshold Pₛ is a pressure value compared with the latest pressure value P_{now} to be used as a trigger for causing the display device 100 to select the pointed position (X₀, Y₀). The mode-in threshold Pᵢₙ is a pressure value compared with the latest pressure value P_{now} to be used as a trigger for causing the display device 100 to switch to the extension mode.

### [Storage Contents of Mode Management Table 600]

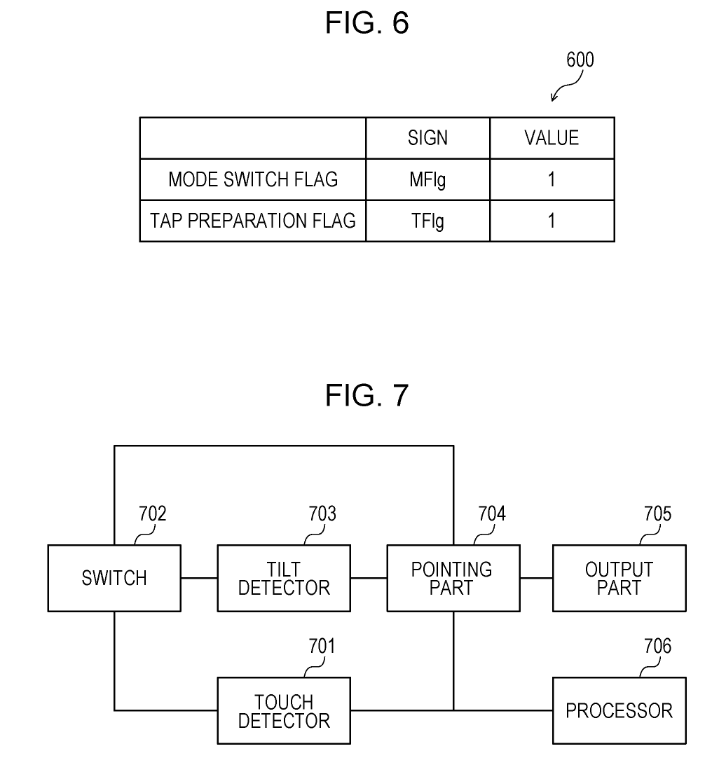

FIG. 6 is an explanatory diagram illustrating an example of storage contents in a mode management table 600. As illustrated in FIG. 6, the mode management table 600 includes fields for a mode switch flag MFlg and a tap preparation flag TFlg. Mode management information is stored in the mode management table 600 by setting information in each field every time the mode is changed.

The mode switch flag MFlg is a flag indicating whether the display device 100 is in the normal mode or the extension mode. The mode switch flag MFlg being 1 indicates that the display device 100 is in the extension mode and the mode switch flag MFlg being 0 indicates that the display device 100 is in the normal mode. The tap preparation flag TFlg is a flag indicating whether the display device 100 is in a mode of accepting a tap operation input or not. The tap preparation flag TFlg being 1 indicates that the display device 100 is in the mode of accepting the tap operation input and the tap preparation flag TFlg being 0 indicates that the display device 100 is not in the mode of accepting the tap operation input.

### [Functional Configuration Example of Display Device 100]

Next, a functional configuration example of the display device 100 is described by using FIG. 7.

FIG. 7 is a block diagram illustrating a functional configuration example of the display device 100. The display device 100 includes a touch detector 701, a switch 702, a tilt detector 703, a pointing part 704, an output part 705, and a processor 706.

The touch detector 701 to the processor 706 implement functions which serve as a controller, by for example causing the CPU 201 to execute the programs stored in the memory 202 illustrated in FIG. 2, by using the communication unit 203, or by using the input-output device 204. Processing results of the functional parts are stored in, for example, a storage region such as the memory 202 illustrated in FIG. 2.

The touch detector 701 detects the touch position on the touch panel 110. The touch position is, for example, the touch position described above and is a position touched by the finger of the user, the pen, or the like. For example, the touch detector 701 detects the touch position (X_{now}, Y_{now}) when the finger of the user, the pen, or the like touches the touch panel 110. Accordingly, the touch detector 701 may detect the touch position to be the parameter used when the pointing part 704 points the position, and output the touch position to the pointing part 704.

The switch 702 performs switching to a first mode in which a position different from the touch position on the touch panel 110 is pointed, in response to a predetermined operation input. The first mode is the extension mode described above. The switch 702 switches the display device 100 from the normal mode to the extension mode in response to, for example, pressing down of the touch panel 110 at a predetermined pressure or more.

The switch 702 performs switching to a second mode in which the touch position on the touch panel 110 is pointed, in response to acceptance of a predetermined operation input after the switching to the mode in which a position different from the touch position on the touch panel 110 is pointed. The predetermined operation input is, for example, an operation input indicating that the user stops touching the touch panel 110. The second mode is the normal mode described above. The switch 702 switches the display device 100 from the extension mode to the normal mode when the user stops touching the touch panel 110. The switch 702 may thus appropriately set the display device 100 to the normal mode or the extension mode depending on the situation.

### [Examples of Operations in Extension Mode]

Now, examples of operations of the display device 100 in the extension mode are described. The examples of operations of the display device 100 in the extension mode are implemented by the tilt detector 703, the pointing part 704, the output part 705, and the processor 706.

The tilt detector 703 detects the tilt of the display device 100. The tilt detector 703 detects the tilt θ of the display device 100 with respect to the horizontal plane by using the sensor 206. The tilt detector 703 may thus detect the tilt of the display device 100 to be the parameter used in the pointing of the position and output the tilt to the pointing part 704.

The pointing part 704 calculates the distance from the reference position to the touch position on the touch panel 110 which is detected by the touch detector 701. The distance from the reference position to the touch position is, for example, an Euclidean distance from the reference position to the touch position. The distance from the reference position to the touch position may be, for example, coordinate values of the touch position with the reference position as the origin and be a distance on the coordinate axes.

For example, the pointing part 704 sets the first position among multiple continuously-touched positions on the touch panel 110 as the reference position and calculates the distance from the set reference position to the last position among the multiple positions. The continuous touch is, for example, a situation where the user slides the finger on the touch panel 110 without taking the finger off the touch panel 110. The continuous touch may be a situation where the user touches the touch panel 110 with the finger multiple times at intervals of a predetermined time or less.

Specifically, when the user slides the finger touching the touch panel 110, the pointing part 704 calculates the distance from the first touch position in the sliding to the latest touch position in the sliding. The pointing part 704 may thus calculate the distance to be the parameter used in the pointing of the position.

Next, the pointing part 704 points a position different from the touch position on the touch panel 110 which is detected by the touch detector 701, based on the tilt detected by the tilt detector 703, the touch position detected by the touch detector 701, and the calculated distance. For example, the pointing part 704 points a position different from the last position among the multiple continuously-touched positions on the touch panel 110, based on the tilt detected by the tilt detector 703, the touch position detected by the touch detector 701, and the calculated distance. Specifically, when the user slides the finger touching the touch panel 110, the pointing part 704 points a position different from at least the latest touch position in the sliding. The pointing part 704 may thus allow the user to determine the reference position and then point a position different from the latest touch position of the user, thereby improving the operability of the touch panel 110.

Moreover, for example, the pointing part 704 points a position based on the detected tilt, the detected touch position, and the calculated distance, the position being different from the touch position on the touch panel 110 and existing on an extended line obtained by extending a straight line, connecting the reference position and the touch position, from the touch position. The pointing part 704 thus allows the user to intuitionally point a position by pointing a position which is farther from the reference position than the position touched by the finger of the user is and which exists in the direction pointed by the finger of the user.

Moreover, for example, the pointing part 704 points a position away from the reference position by a distance obtained by multiplying the calculated distance by a coefficient corresponding to the detected tilt. Specifically, the pointing part 704 calculates a tilt coefficient f(θ) by plugging the tilt (θ) into a function f, and points a position away from the reference position by a distance obtained by multiplying the calculated distance by the length coefficient N and the tilt coefficient f(θ). For example, the function f is an expression whose value becomes larger as θ becomes larger. The function f is an expression capable of calculating the value by which the calculated distance is to be multiplied.

The pointing part 704 may obtain the coefficient corresponding to the detected tilt by using association information in which a range of the tilt θ and a coefficient for the case where the tilt θ is within the range are associated with each other, and point a position away from the reference position by a distance obtained by multiplying the calculated distance by the length coefficient N and the obtained coefficient. The pointing part 704 thus allows the user to intuitionally point a position by causing the pointed position to continuously change when any of the coefficient corresponding to the tilt and the calculated distance changes.

Furthermore, for example, the pointing part 704 points a position away from the reference position by a distance obtained by adding a distance corresponding to the detected tilt to the calculated distance. Specifically, the pointing part 704 calculates a variable distance g(θ) by plugging the tilt θ into a function g, and points a position away from the reference position by a distance equal to a sum of the calculated distance and a distance obtained by multiplying the variable distance g(θ) by the length coefficient N. For example, the function g is an expression whose value becomes larger as θ becomes larger. The function g is an expression capable of calculating the value by which the length coefficient N is to be multiplied.

The pointing part 704 may obtain a variable distance corresponding to the detected tilt by using association information in which a range of the tilt θ and a variable distance for the case where the tilt θ is within the range are associated with each other. Then, the pointing part 704 may point a position away from the reference position by a distance equal to a sum of the calculated distance and a distance obtained by multiplying the variable distance by the length coefficient N. The pointing part 704 thus allows the user to intuitionally point a position by causing the pointed position to continuously change when any of the tilt coefficient f(θ) and the calculated distance changes. Moreover, the pointing part 704 is capable of improving the operability of the touch panel 110 by changing the pointed position at a fixed rate relative to a change of the position touched by the user, regardless of the change of the tilt of the display device 100.

The output part 705 displays an icon at the position pointed by the pointing part 704, the icon indicating the pointing of the position. The output part 705 displays a cursor at the position pointed by the pointing part 704. The output part 705 is thus capable of improving the operability of the touch panel 110 by allowing the user to grasp the pointed position and making it easier for the user to point a desired position.

The processor 706 performs, in response to acceptance of a predetermined operation after the pointing of the position by the pointing part 704, a process corresponding to the position pointed by the pointing part 704 and the predetermined operation. For example, when the touch panel 110 is tapped after the pointing of the position by the pointing part 704, the processor 706 handles the tap as a tap for the position pointed by the pointing part 704 and performs a tap process for the position pointed by the pointing part 704. The user may thus point an untouched position and cause the display device 100 to perform the tap process and the like for the untouched position.

### [Examples of Operations in Normal Mode]

Now, examples of operations of the display device 100 in the normal mode are described. The examples of operations of the display device 100 in the normal mode are implemented by the pointing part 704, the output part 705, and the processor 706.

The pointing part 704 points a touch position on the touch panel 110 which is detected by the touch detector 701. The pointing part 704 may thus directly point the position touched by the user. Since the operations of the output part 705 are the same as those in the extension mode, description thereof is omitted. Since the operations of the processor 706 are the same as those in the extension mode, description thereof is omitted.

In this example, although description is given of the case where the switch 702 performs switching between the normal mode and the extension mode, the embodiment is not limited to this example. For example, the display device 100 may include no switch 702 and operate in the extension mode.

### [Example of Display Device 100 Pointing Position]

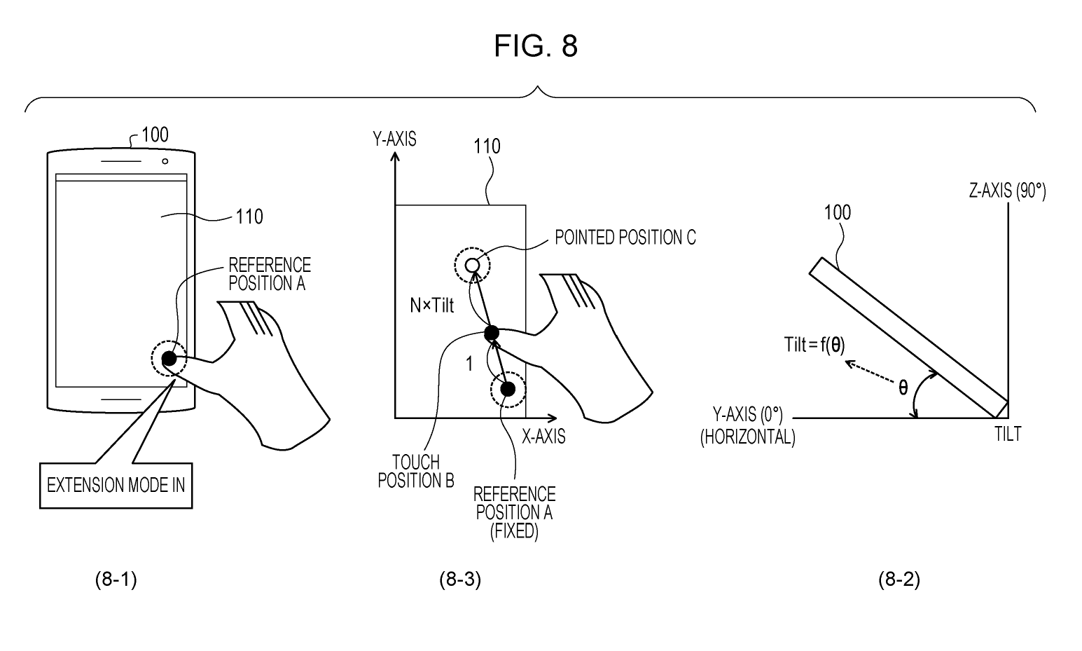

Next, an example of the display device 100 pointing a position is described by using FIG. 8.

FIG. 8 includes explanatory diagrams illustrating the example of the display device 100 pointing a position. In the example of FIG. 8, the display device 100 is assumed to detect the touch position B on the touch panel 110 in real time and manage the coordinate values of the latest touch position B by storing the coordinate values in the position management table 300.

(8-1) The display device 100 switches itself to the extension mode in response to pressing down of the touch panel 110 by the user at the predetermined pressure or more. In this case, when the display device 100 switches to the extension mode, the display device 100 may update the mode switch flag of the mode management table 600 and manages whether the display device 100 is in the normal mode or the extension mode.

Moreover, the display device 100 sets the position pressed down at the predetermined pressure or more as the reference position A. In this case, the display device 100 may manage the reference position A by storing the coordinate values of the reference position A in the position management table 300. The display device 100 is thus allowed to point a position other than the position touched by the user. Moreover, the display device 100 may set a position desired by the user as the reference position A and allow the user to move the pointed position C based on the reference position A preferable for the user.

(8-2) When the display device 100 switches to the extension mode, the display device 100 detects the tilt θ of itself with respect to the horizontal plane in real time and calculates the tilt coefficient Tilt=f(θ) by using the function f. In this case, the display device 100 may manage the tilt θ and the tilt coefficient Tilt by storing the tilt θ and the tilt coefficient Tilt in the coefficient management table 400 every time the tilt θ is detected. The display device 100 may thus add the tilt coefficient Tilt to the parameters used in the pointing of a position other than the position touched by the user.

(8-3) When the display device 100 switches to the extension mode, the display device 100 calculates a reference distance from the reference position A to the latest touch position B touched by the user, by referring to the position management table 300. The display device 100 may thus add the reference distance to the parameters used in the pointing of a position other than the position touched by the user.

The display device 100 obtains the tilt coefficient Tilt and the length coefficient N from the coefficient management table 400. The display device 100 points the position C which is farther from the reference position A than the latest touch position B is and which is different from the latest touch position B, such that a relationship of “reference distance : distance from latest touch position B to pointed position=1: length coefficient N×tilt coefficient Tilt” is established.

When the display device 100 points the position C, the display device 100 displays a cursor at the pointed position C on the touch panel 110. In this case, the display device 100 may manage the pointed position C by storing the coordinate values of the pointed position C in the position management table 300 every time the pointed position C changes. The display device 100 may thus point a position which is difficult for the user to touch and improve the operability of the touch panel 110.

Moreover, in the case of enabling the user to point the entire region of the touch panel 110, the display device 100 may use the tilt coefficient Tilt in addition to the length coefficient N and does not have to set the length coefficient N to a relatively large value. Accordingly, the display device 100 is capable of reducing the case where, although the finger is moved by a relatively small amount, the display position of the cursor is moved by a relatively large amount and the user feels difficulty in the operation.

In this example, although description is given of the case where the reference position A is variable, the embodiment is not limited to this example. For example, the reference position A may be fixed. Specifically, the reference position A may be fixed at a lower right position of the touch panel 110. Alternatively, the reference position A may be fixed at a lower left position of the touch panel 110.

Furthermore, the display device 100 may have a function of determining whether the user is holding the display device with the right hand or the left hand. Then, when the user is holding the display device 100 with the right hand, the display device 100 may fix the reference position A at the lower right position of the touch panel 110 which is close to the hand of the user. Meanwhile, when the user is holding the display device 100 with the left hand, the display device 100 may fix the reference position A at the lower left position of the touch panel 110 which is close to the hand of the user.

Moreover, the display device 100 may store the tilt coefficient Tilt when returning to the normal mode, and point the position C by using the stored tilt coefficient Tilt without changing the tilt coefficient Tilt when switching to the extension mode next time.

### [Another Example of Display Device 100 Pointing Position]

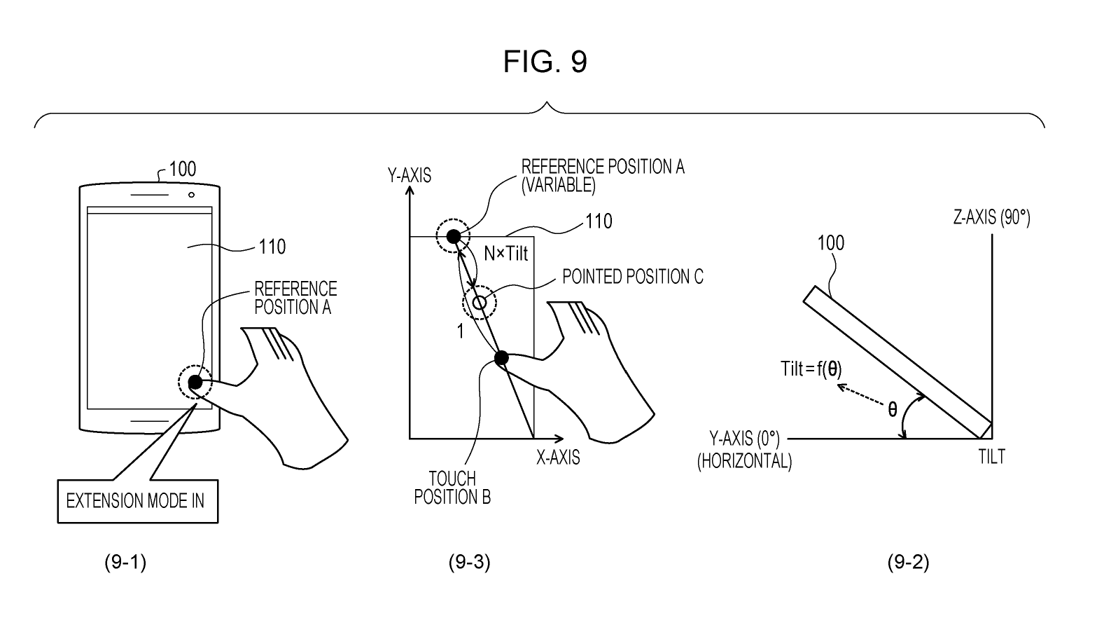

Next, another example of the display device 100 pointing a position is described by using FIG. 9.

FIG. 9 includes explanatory diagrams illustrating the other example of the display device 100 pointing a position. In the example of FIG. 8 described above, although description is given of the case where the reference position A is the position where the user presses down the touch panel 110 at the predetermined pressure or more, the embodiment is not limited to this example. For example, the reference position A may be a position fixed anywhere in the outer peripheral portion of the touch panel 110 or a variable position in the outer peripheral portion of the touch panel 110.

In the example of FIG. 9, the reference position A is a variable position in the outer peripheral portion of the touch panel 110. Moreover, the display device 100 is assumed to detect the touch position B on the touch panel 110 in real time and manage the coordinate values of the latest touch position B by storing the coordinate values in the position management table 300.

(9-1) The display device 100 switches itself to the extension mode in response to pressing down of the touch panel 110 by the user at the predetermined pressure or more. In this case, when the display device 100 switches to the extension mode, the display device 100 may update the mode switch flag of the mode management table 600 and manages whether the display device 100 is in the normal mode or the extension mode. The display device 100 may thus point a position other than the position touched by the user.

(9-2) When the display device 100 switches to the extension mode, the display device 100 detects the tilt θ of itself with respect to the horizontal plane in real time and calculates the tilt coefficient Tilt=f(θ) by using the function f. In this case, the display device 100 may manage the tilt θ and the tilt coefficient Tilt by storing the tilt θ and the tilt coefficient Tilt in the coefficient management table 400 every time the tilt θ is detected. The display device 100 may thus add the tilt coefficient Tilt to the parameters used in the pointing of a position other than the position touched by the user.

(9-3) When the display device 100 switches to the extension mode, the display device 100 sets, as the reference position A, an intersection between the outer peripheral portion of the touch panel 110 and an extended line obtained by extending a straight line, connecting the lower right position of the touch panel 110 and the latest touch position B, from the latest touch position B. In this case, the display device 100 may mange the reference position A by storing the coordinate values of the reference position A in the position management table 300.

Moreover, the display device 100 calculates the reference distance from the reference position A to the latest touch position B touched by the user, by referring to the position management table 300. The display device 100 may thus add the reference distance to the parameters used in the pointing of a position other than the position touched by the user.

The display device 100 obtains the tilt coefficient Tilt and the length coefficient N from the coefficient management table 400. The display device 100 points the position C which is a position between the latest touch position B and the reference position A and which is different from the latest touch position B, such that the relationship of “reference distance : distance from latest touch position B to pointed position=1: length coefficient N×tilt coefficient Tilt” is established.

When the display device 100 points the position C, the display device 100 displays a cursor at the pointed position C on the touch panel 110. In this case, the display device 100 may manage the pointed position C by storing the coordinate values of the pointed position C in the position management table 300 every time the pointed position C changes. The display device 100 may thus point a position which is difficult for the user to touch and improve the operability of the touch panel 110.

Moreover, in the case of enabling the user to select the entire region of the touch panel 110, the display device 100 may use the tilt coefficient Tilt in addition to the length coefficient N and does not have to set the length coefficient N to a relatively large value. Accordingly, the display device 100 is capable of reducing the case where, although the finger is moved by a relatively small amount, the display position of the cursor is moved by a relatively large amount and the user feels difficulty in the operation.

[Example of Changing Pointed position in Display Device 100]

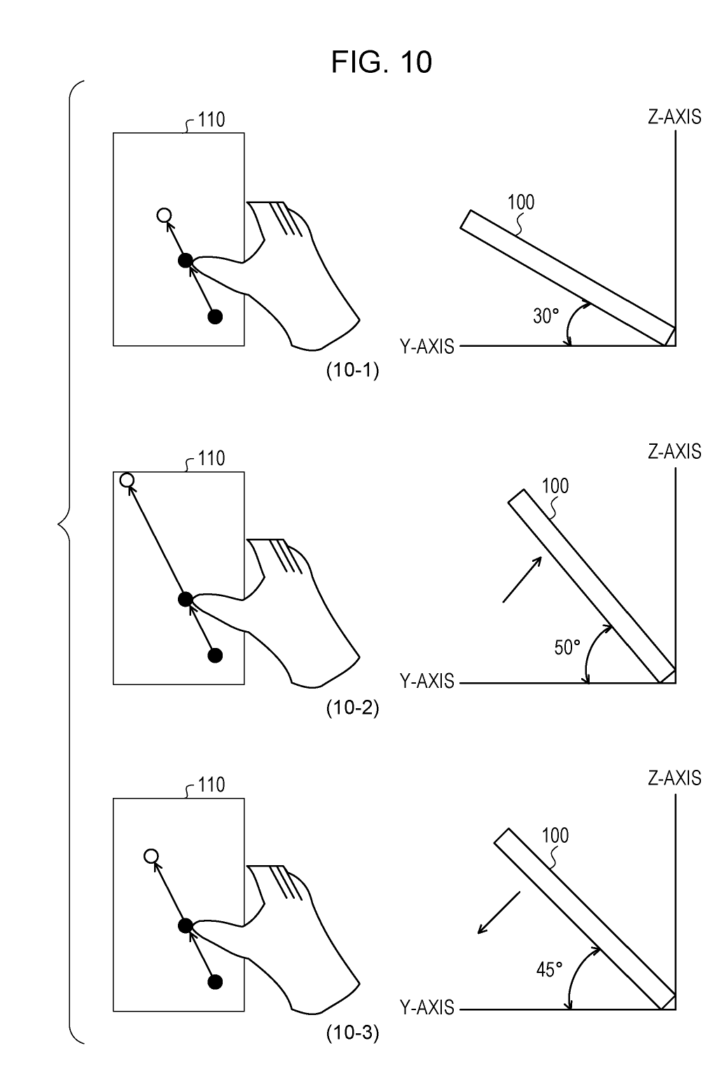

Next, an example of changing the pointed position in the display device 100 is described by using FIG. 10.

FIG. 10 includes explanatory diagrams illustrating the example of changing the pointed position in the display device 100. In FIG. 10, (10-1) when the display device 100 is in the extension mode and the tilt θ of the display device 100 is 30°, the user touches the touch panel 110 with the finger and causes the cursor to be displayed on the touch panel 110.

(10-2) The user tries to move the display position of the cursor on the touch panel 110 away from the reference position A while touching the touch panel 110 with the finger. In this case, the user may cause the cursor to be displayed in a vicinity of an upper left portion of the touch panel 110 without moving the finger by setting the tilt θ of the display device 100 to 50°. The user may thus adjust the display position of the cursor without delicately moving the finger to adjust the touch position.

(10-3) The cursor is moved beyond and away from the desired position and the user tries to move the display position of the cursor on the touch panel 110 closer to the reference position A. In this case, the user may move the display position of the cursor close to the desired position without moving the finger by setting the tilt θ of the display device 100 to 45°. The user may thus adjust the display position of the cursor without delicately moving the finger to adjust the touch position.

Moreover, it is possible to avoid a situation where, when the user operates the display device 100 with one hand, the user delicately moves the finger of the hand holding the display device 100 and becomes unable to stably hold the display device 100. Accordingly, the user may move the display position of the cursor by changing the tilt of the display device 100 while stably holding the display device 100 and thus move the display position of the cursor to the desired position.

[Another Example of Changing Pointed position in Display Device 100]

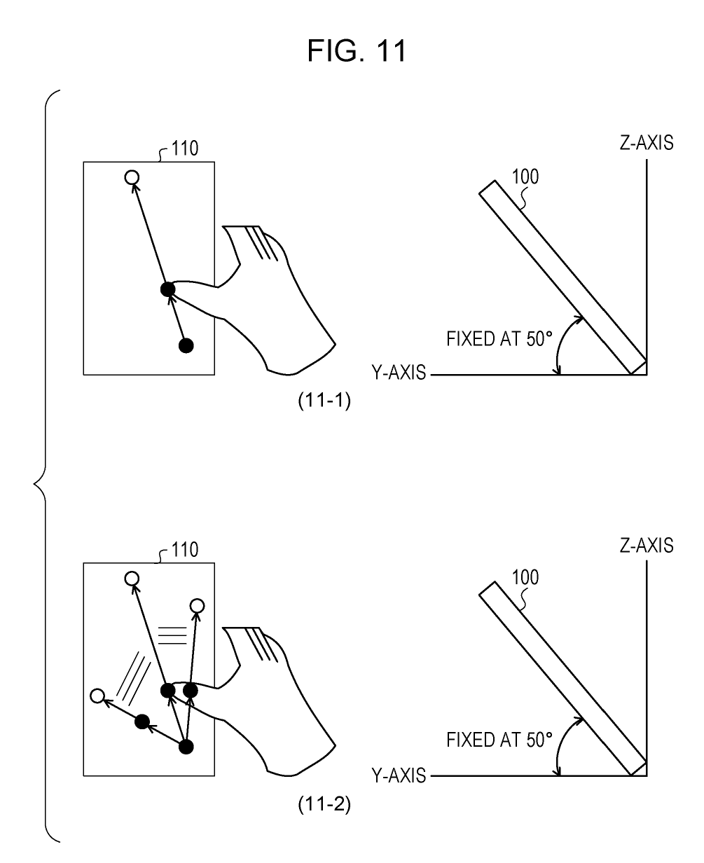

Next, another example of changing the pointed position in the display device 100 is described by using FIG. 11.

FIG. 11 is explanatory diagrams illustrating the other example of changing the pointed position in the display device 100. In FIG. 11, (11-1) when the display device 100 is in the extension mode, the user may maintain the tilt coefficient to a desired value by maintaining the tilt θ of the display device 100 to 50°. The user may thus maintain sensitivity indicating the change of the display position of the cursor relative to the change of the position of the finger, to sensitivity preferable for the user.

(11-2) The user may move the display position of the cursor at the sensitivity preferable for the user by moving the finger on the touch panel 110 with the tilt coefficient Tilt being fixed. The user may thus adjust the display position of the cursor at the sensitivity preferable for the user and move the cursor to the desired position.

[Example of User Operation Input into Display Device 100]

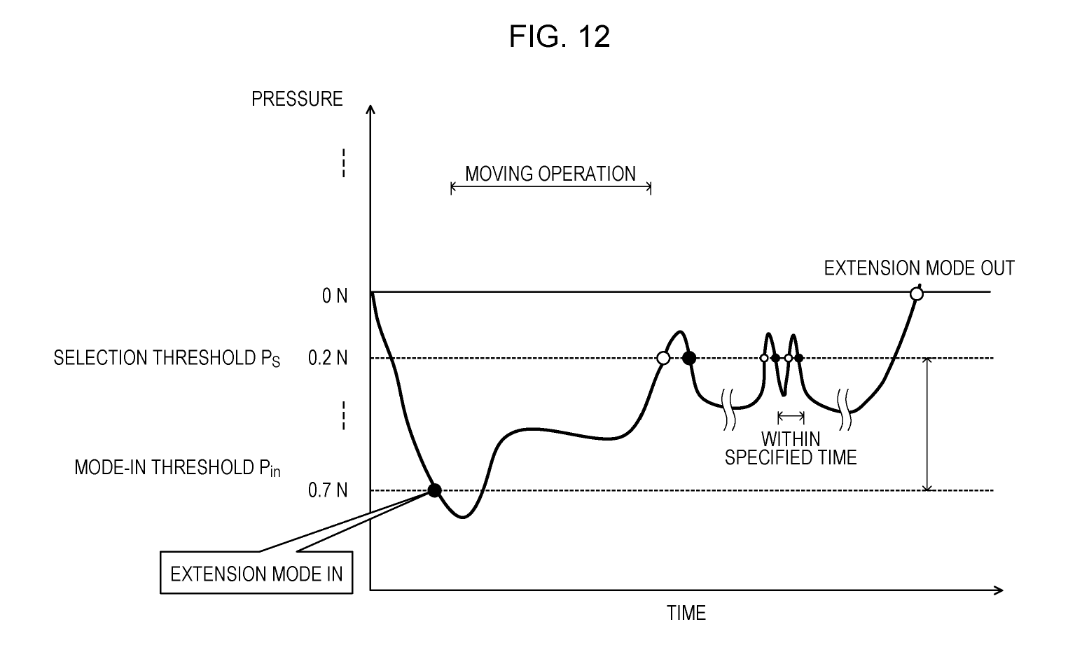

Next, an example of an user operation input into the display device 100 performed when the display device 100 switches to the extension mode and the cursor is displayed at the pointed position C is described by using FIG. 12.

FIG. 12 is an explanatory diagram illustrating an example of the user operation input into the display device 100. In FIG. 12, the display device 100 detects the latest pressure value P_{now} of pressing-down of the touch panel 110 by the user in real time. In this case, the display device 100 may manage the pointed position C by storing the detected latest pressure value P_{now} in the touch management table 500. The graph of FIG. 12 depicts a time-series change of the latest pressure value P_{now}.

For example, the display device 100 obtains the mode-in threshold Pᵢₙ from the touch management table 500, and determines whether the latest pressure value P_{now} has exceeded the mode-in threshold Pᵢₙ or not. In response to the latest pressure value P_{now} exceeding the mode-in threshold Pᵢₙ, the display device 100 switches itself to the extension mode. In this case, when the display device 100 switches to the extension mode, the display device 100 may update the mode switch flag of the mode management table 600 and manages whether the display device 100 is in the normal mode or the extension mode. Thereafter, the display device 100 points a position other than the position touched by the user on the touch panel 110 and displays the cursor at the pointed position C until the latest pressure value P_{now} falls below the selection threshold Pₛ.

The display device 100 obtains the selection threshold Pₛ from the touch management table 500 and determines whether the latest pressure value P_{now} has fallen below the selection threshold Pₛ or not. In this case, the display device 100 accepts the tap operation input in response to the latest pressure value P_{now} falling below the selection threshold Pₛ. The tap operation input is, for example, a single tap operation input. The tap operation input may be a double tap operation input. When the latest pressure value P_{now} falls below the selection threshold Pₛ and then exceeds the selection threshold Pₛ again, the display device 100 accepts the tap operation input for the display position of the cursor.

Moreover, when the latest pressure value P_{now} falls below the selection threshold Pₛ and then exceeds the selection threshold P_{s now} again and thereafter falls below the selection threshold Pₛ and then exceeds the selection threshold Pₛ one more time within a specified time, the display device 100 accepts the double tap operation input for the display position of the cursor. The display device 100 switches itself to the normal mode when the user stops touching the touch panel 110 and the latest pressure value P_{now} falls to 0. In this case, when the display device 100 switches to the normal mode, the display device 100 may update the mode switch flag of the mode management table 600 to manage whether the display device 100 is in the normal mode or the extension mode.

The user may thus point the desired position on the touch panel 110 and cause the display device 100 to accept the operation input for the pointed position C. As a result, the display device 100 is capable of improving the operability of the display device 100.

Moreover, the display device 100 may switch to the extension mode in response to the pressing-down of the touch panel 110 by the user at a pressure of the mode-in threshold Pᵢₙ or more. Accordingly, when the user desires to use the extension mode, the user may cause the display device 100 to switch to the extension mode without tapping a certain button on the touch panel 110 or taking the finger off the touch panel 110 to press down a physical button. As a result, the display device 100 is capable of improving the operability of the display device 100.

Meanwhile, the display device 100 may return to the normal mode when the user stops the touching of the touch panel 110. Accordingly, when the user desires to cancel the extension mode, the user may cause the display device 100 to switch to the normal mode without tapping a certain button on the touch panel 110 or taking the finger off the touch panel 110 to press down a physical button. As a result, the display device 100 may improve the operability of the display device 100.

### [Example of User Pointing Desired Position]

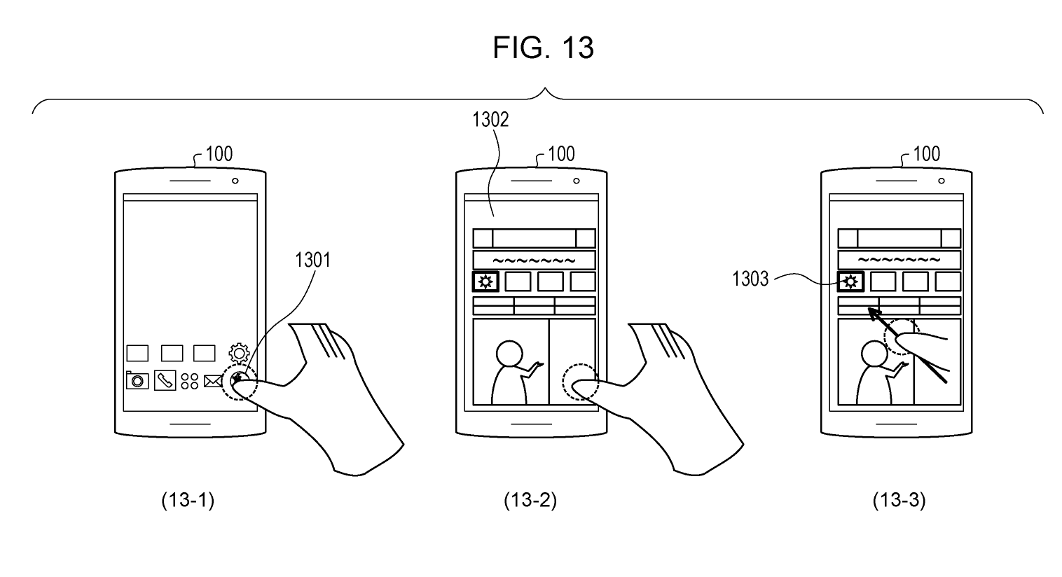

Next, an example of the user pointing the desired position is described by using FIGS. 13 to 15.

FIGS. 13 to 15 include explanatory diagrams illustrating the example of the user pointing the desired position. In the example of FIG. 13, (13-1) the user taps a position on the touch panel 110 where a browser icon 1301 for browsing sites on the Internet is displayed. In the normal mode, the display device 100 points the position touched by the user and accepts the tap operation input for the pointed position C. Since the pointed position C is included in a region where the browser icon 1301 is displayed, the display device 100 displays a screen 1302 of a browsing application on the touch panel 110.

(13-2) The user presses down the touch panel 110 at the predetermined pressure or more. The display device 100 switches itself from the normal mode to the extension mode in response to the pressing-down of the touch panel 110 at the predetermined pressure or more, and displays the cursor at the pointed position C according to the tilt of itself and the touch position B.

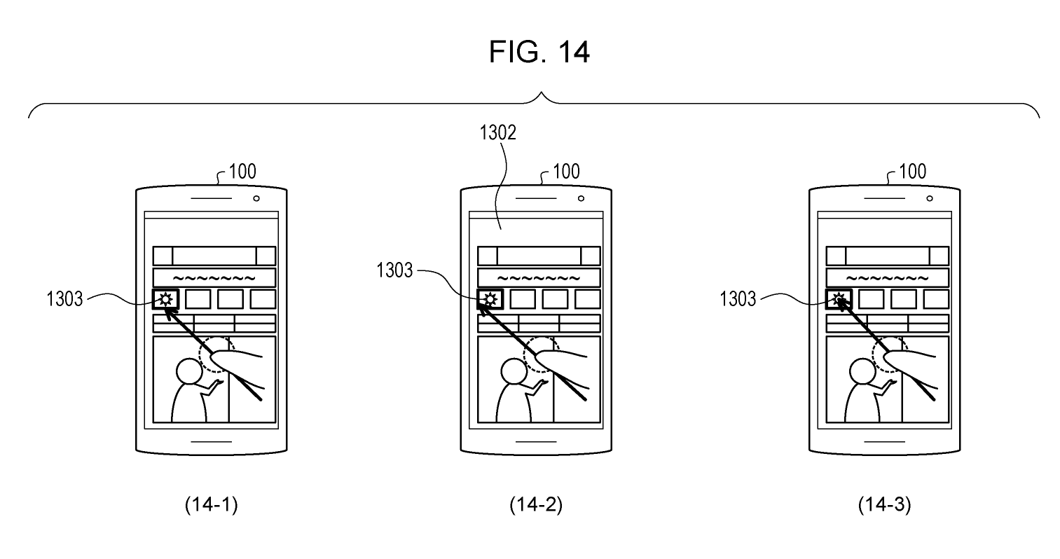

(13-3) The user moves the display position of the cursor by moving the finger on the touch panel 110 and tries to point a position of a weather icon 1303 on the upper left side. However, in this case, even if the user stretches out the finger all the way, the display position of the cursor does not reach a vicinity of a region where the weather icon 1303 is displayed, and the user is unable to point the region where the weather icon 1303 is displayed. Next, the description proceeds to explanation of FIG. 14.

In the example of FIG. 14, (14-1) the user changes the tilt of the display device 100 to increase the tilt coefficient Tilt and moves the display position of the cursor away from the reference position A. However, in this case, the display position of the cursor does not reach the vicinity of the region where the weather icon 1303 is displayed and the user is unable to point the region where the weather icon 1303 is displayed.

(14-2) The user further changes the tilt of the display device to increase the tilt coefficient Tilt and causes the display position of the cursor to move farther away from the reference position A. The user may thus cause the display position of the cursor to reach the vicinity of the region where the weather icon 1303 is displayed.

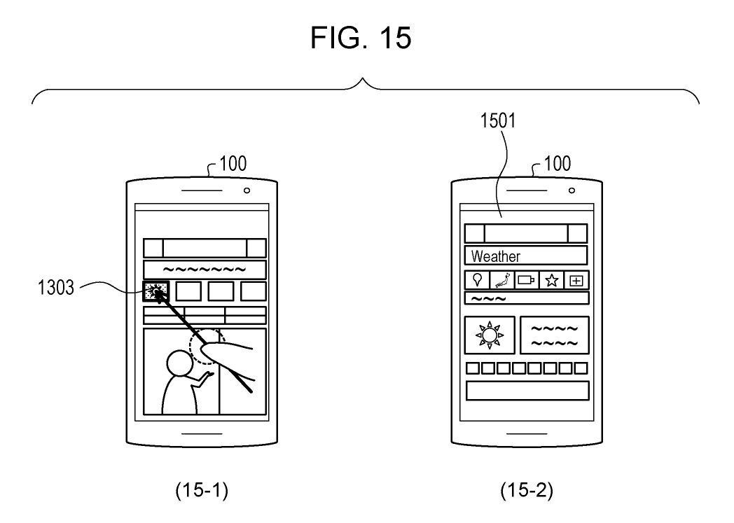

(14-3) The user adjusts the position touched by the finger on the touch panel 110 while maintaining the tilt of the display device 100 and moves the display position of the cursor to the region where the weather icon 1303 is displayed. The user is thus allowed to perform the tap operation input for a position in the region where the weather icon 1303 is displayed. Next, description proceeds to explanation of FIG. 15.

In the example of FIG. 15, (15-1) the user temporarily takes the finger off the touch panel 110 to tap the touch panel 110. The user may thus perform the tap operation input for the display position of the cursor. Since the pointed position C is included in the region where the weather icon 1303 is displayed, the display device 100 displays a screen corresponding to the weather icon 1303 on the touch panel 110.

(15-2) The user may browse a weather forecast screen 1501 corresponding to the weather icon 1303. Accordingly, the user may point a position on the touch panel 110 out of reach of the finger and select the entire region of the touch panel with one hand, and the operation of touch panel 110 is facilitated.

### [Example of Pointing Process Procedure]

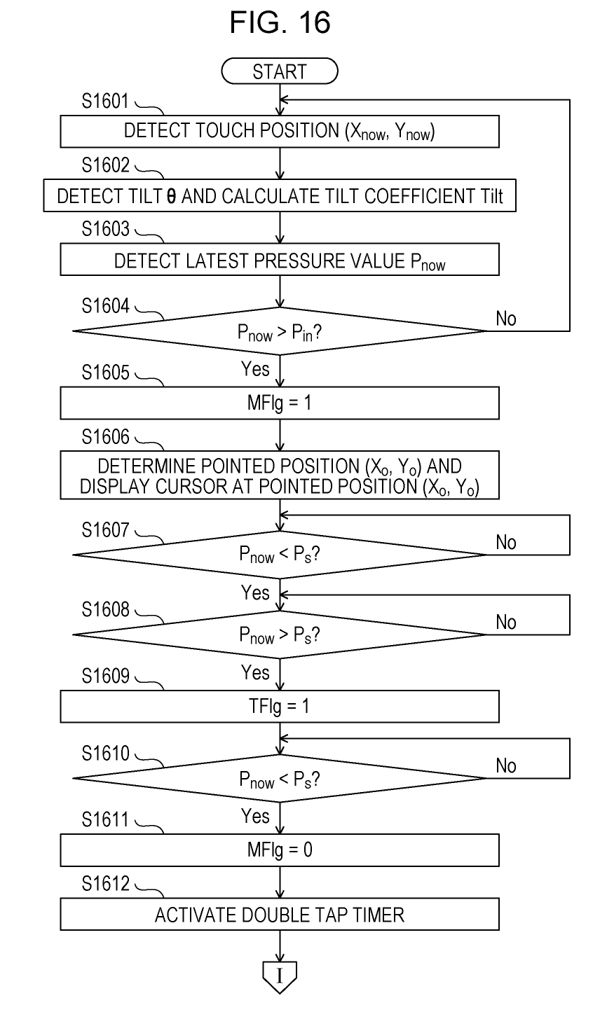

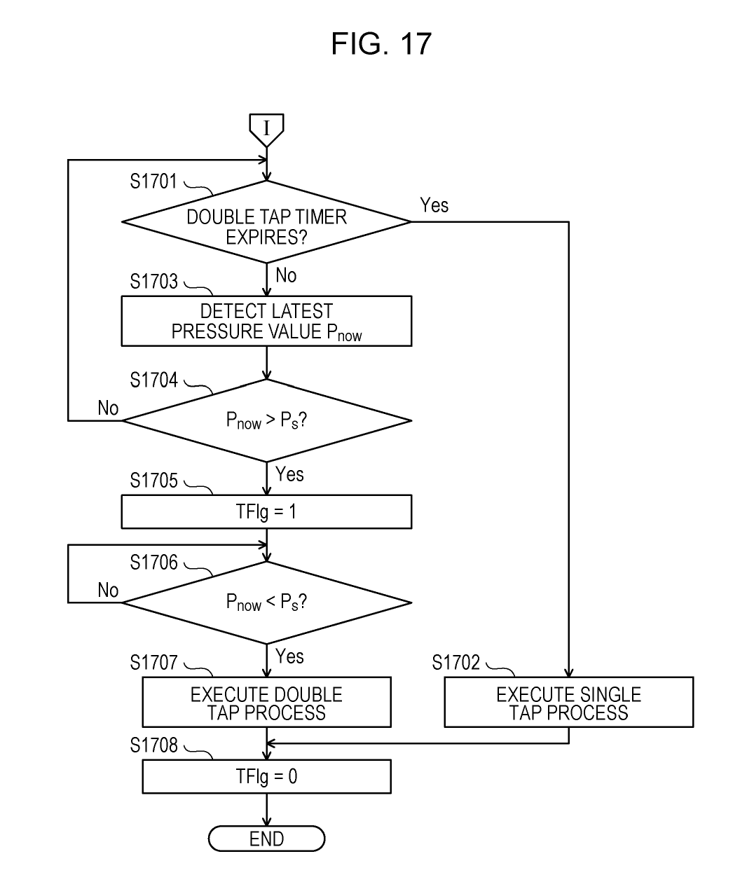

Next, an example of a pointing process procedure executed by the display device 100 is described by using FIGS. 16 and 17.

FIGS. 16 and 17 are flowcharts illustrating an example of the pointing process procedure. In FIG. 16, the display device 100 detects the touch position (X_{now}, Y_{now}) (operation S1601). Next, the display device 100 detects the tilt θ of itself and calculates the tilt coefficient Tilt (operation S1602). Then, the display device 100 detects the latest pressure value P_{now} at which the touch panel 110 is pressed down (operation S1603).

Next, the display device 100 determines whether latest pressure value P_{now}>mode-in threshold Pᵢₙ is satisfied or not (operation S1604). In this case, when latest pressure value P_{now}>mode-in threshold Pin is not satisfied (operation S1604: No), the display device 100 returns to the process of operation S1601.

Meanwhile, when latest pressure value P_{now}>mode-in threshold Pᵢₙ is satisfied (operation S1604: Yes), the display device 100 switches itself to the extension mode and sets the mode switch flag Mflg to 1 (operation S1605). Next, the display device 100 determines the pointed position (X₀, Y₀) based on the reference position (X_{A}, Y_{A}), the touch position (X_{now}, Y_{now}), and the tilt coefficient Tilt and displays the cursor at the pointed position (X₀, Y₀) (operation S1606).

Then, the display device 100 determines whether latest pressure value P_{now}<selection threshold Pₛ is satisfied or not (operation S1607). In this case, when latest pressure value P_{now}<selection threshold Pₛ is not satisfied (operation S1607: No), the display device 100 returns to the process of operation S1607.

Meanwhile, when latest pressure value P_{now}<selection threshold Pₛ is satisfied (operation S1607: Yes), the display device 100 determines whether latest pressure value P_{now}>selection threshold Pₛ is satisfied or not (operation S1608). In this case, when latest pressure value P_{now}>selection threshold Pₛ is not satisfied (operation S1608: No), the display device 100 returns to the process of operation S1608.

Meanwhile, when latest pressure value P_{now}>selection threshold Pₛ is satisfied (operation S1608: Yes), the display device 100 proceeds to preparation of accepting the tap operation input and sets the tap preparation flag Tflg to 1 (operation S1609).

Next, the display device 100 determines whether latest pressure value P_{now}<selection threshold Pₛ is satisfied or not (operation S1610). In this case, when latest pressure value P_{now}<selection threshold Pₛ is not satisfied (operation S1610: No), the display device 100 returns to the process of operation S1610.

Meanwhile, when latest pressure value P_{now}<selection threshold Pₛ is satisfied (operation S1610: Yes), the display device 100 switches itself to the normal mode and sets the mode switch flag Mflg to 0 (operation S1611). Next, the display device 100 activates a double tap timer (operation S1612). Then, the display device 100 proceeds to the process of operation S1701 in FIG. 17.

In FIG. 17, the display device 100 determines whether the double tap timer expires or not (operation S1701). In this case, when the double tap timer expires (operation S1701: Yes), the display device 100 executes a single tap process (operation S1702) and proceeds to the process of operation S1708.

Meanwhile, when the double tap timer is not expired (operation S1701: No), the display device 100 detects the latest pressure value P_{now} (operation S1703). Next, the display device 100 determines whether latest pressure value P_{now}>selection threshold Pₛ is satisfied or not (operation S1704). In this case, when latest pressure value P_{now}>selection threshold Pₛ is not satisfied (operation S1704: No), the display device 100 returns to the process of operation S1701.

Meanwhile, when latest pressure value P_{now}>selection threshold Pₛ is satisfied (operation S1704: Yes), the display device 100 proceeds to the preparation of accepting the tap operation input and sets the tap preparation flag TFlg to 1 (operation S1705).

Next, the display device 100 determines whether latest pressure value P_{now}<selection threshold Pₛ is satisfied or not (operation S1706). In this case, when latest pressure value P_{now}<selection threshold Pₛ is not satisfied (operation S1706: No), the display device 100 returns to the process of operation S1706.

Meanwhile, when latest pressure value P_{now}<selection threshold Pₛ is satisfied (operation S1706: Yes), the display device 100 executes a double tap process (operation S1707). Next, the display device 100 sets the tap preparation flag TFlg to 0 (operation S1708). Then, the display device 100 terminates the pointing process. Accordingly, the display device 100 may point a position other than the touch position.

As described above, the display device 100 may point a position different from the touch position on the touch panel 110, based on the tilt of itself and the distance from the reference position to the touch position on the touch panel 110. Accordingly, the display device 100 may use the tilt of itself, in addition to the reference distance corresponding to the touch position, as the parameter used in the pointing of the position, and increase the types of parameters adjustable by the user. The display device 100 may thereby facilitate the pointing of the position desired by the user and improve the operability of the touch panel 110.

Moreover, the display device 100 may set the first position among the multiple continuously-touched positions on the touch panel 110 as the reference position. Then, the display device 100 may calculate the distance from the set reference position to the last position among the multiple positions and point a position on the touch panel 110 which is different from the last position, based on the tilt of itself and the calculated distance. Accordingly, the display device 100 may allow the user to determine the reference position and then point a position different from the latest touch position of the user, thereby improving the operability of the touch panel 110.

Furthermore, the display device 100 may point a position based on the tilt of itself and the distance from the reference position to the touch position on the touch panel 110, the position existing on the extended line obtained by extending the straight line, connecting the reference position and the touch position, from the touch position. The display device 100 thus allows the user to intuitionally point a position by allowing the user to grasp that a position farther from the reference position than the position touched by the finger of the user is pointed.

Moreover, the display device 100 may point a position away from the reference position on the touch panel 110 by a distance obtained by multiplying the distance from the reference position to the touch position on the touch panel 110 by the coefficient corresponding to the tilt of itself. The display device 100 thus allows the user to intuitionally point a position by causing the pointed position to continuously change when any of the coefficient corresponding to the tilt and the calculated distance changes.

Furthermore, the display device 100 may allow pointing of a position away from the reference position on the touch panel 110 by a distance obtained by adding the distance corresponding to the tilt of itself to the distance from the reference position to the touch position. The display device 100 thus allows the user to intuitionally point a position by causing the pointed position to continuously change when any of the tilt coefficient f(θ) and the calculated distance changes. Moreover, the display device 100 is capable of improving the operability of the touch panel 110 by changing the pointed position at a fixed rate relative to the change of the position touched by the user, regardless of the change of the tilt of the display device 100.

Moreover, the display device 100 may display an icon at the pointed position, the icon indicating the pointing of the position. The display device 100 is thus capable of improving the operability of the touch panel 110 by allowing the user to grasp the pointed position and making it easier for the user to point a desired position.

Furthermore, the display device 100 may perform, in response to acceptance of the predetermined operation after the pointing of the different position, the process corresponding to the different position and the predetermined operation. The user may thus point an untouched position and cause the display device 100 to perform the tap process and the like for the untouched position.

Moreover, the display device 100 may switch to the mode in which the display device 100 points a position different from the touch position on the touch panel 110, in response to the pressing-down of the touch panel 110 at the predetermined pressure or more. The display device 100 is thus capable of appropriately setting itself to the normal mode or the extension mode depending on the situation.

Furthermore, the display device 100 may switch to the mode in which the display device 100 points a touch position on the touch panel 110, in response to acceptance of the predetermined operation after the switching to the mode where the display device 100 points a position different from the touch position on the touch panel 110. The display device 100 is thus capable of appropriately setting itself to the normal mode or the extension mode depending on the situation.

Note that the display control method described in the embodiment may be implemented by causing a computer such as a personal computer or a work station to execute a program prepared in advance. This display control program is recorded on a computer readable recording medium such as a hard disk, a flexible disk, a CD-ROM, a MO disc, a DVD, and the like, and is executed by being read from the recording medium by the computer. Moreover, the display control program may be distributed via a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A display device comprising:
a memory; and
a processor coupled with the memory and the processor configured to:
detect a tilt of the display device;
detect a touch position touched on a touch panel of the display device; and
point a position different from the touch position detected, based on the tilt detected, the touch position detected, and a first distance from a reference position on the touch panel to the touch position detected.

2. The display device according to claim 1,
wherein the processor is further configured to:
set a first position touched first among a plurality of continuously-touched positions on the touch panel, as the reference position;
calculate a second distance from the reference position to a last position touched lastly among the plurality of continuously-touched positions; and
point a position different from the last position on the touch panel, based on the tilt detected, the last position, and the second distance.

3. The display device according to claim 2,
wherein the processor is further configured to:
point a position located on an extended line obtained by extending, to the touch position, a straight line on which the reference position and the touch position are connected with, based on the tilt, the touch position, and the second distance.

4. The display device according to claim 3,
wherein the processor is further configured to:
calculate a third distance by multiplying the second distance by a coefficient corresponding to the tilt; and
point a position away from the reference position by the third distance.

5. The display device according to claim 3,
wherein the processor is further configured to:
calculate a fourth distance by adding a fifth distance corresponding to the tilt to the second distance; and
point a position away from the reference position by the fourth distance.

6. The display device according to claim 1,
wherein the processor is further configured to display an icon at the position different from the touch position, the icon indicating that the position is pointed as a position to be touched on the touch panel.

7. The display device according to claim 6,
wherein the processor is further configured to perform, in response to acceptance of a predetermined operation after the pointing of the position different from the touch position, a process corresponding to the different position and the predetermined operation.

8. The display device according to claim 1,
wherein the processor is further configured to shift to a mode in which the processor points the position different from the touch position on the touch panel, in response to pressing down of the touch panel at a predetermined pressure or more.

9. The display device according to claim 8,
wherein the processor is further configured to shift to a mode where the processor points the touch position on the touch panel, in response to acceptance of a predetermined operation after shifting to the mode in which the processor points the position different from the touch position on the touch panel.

10. A display control method for a display device, the display method comprising:
detecting a tilt of the display device;
detecting a touch position touched on a touch panel of the display device; and
pointing a position different from the touch position detected, based on the tilt detected, the touch position detected, and a distance from a reference position on the touch panel to the touch position detected, as a position to be touched on the touch panel, by a processor.

11. A computer-readable non-transitory recording medium storing a program that causes a computer to execute a procedure for a display device, the procedure comprising:
detecting a tilt of the display device;
detecting a touch position touched on a touch panel of the display device; and
pointing a position different from the touch position detected, based on the tilt detected, the touch position detected, and a distance from a reference position on the touch panel to the touch position detected, as a position to be touched on the touch panel.
